(19) United States
(12) Patent Application Publication
(10) Pub. No.: US 2006/0186168 A1
(43) Pub. Date: Aug. 24, 2006

(54) Stapler

(76) Inventor: Futoshi Kameda, Tokyo (JP)

Correspondence Address: MORGAN LEWIS & BOCKIUS LLP, 1111 PENNSYLVANIA AVENUE NW, WASHINGTON, DC, 20004, US

(21) Appl. No.: 10/566,583

(22) PCT Filed: Jul. 30, 2004
(86) PCT No.: PCT/JP04/11281

§ 371 Date: Jan. 31, 2006

(30) Foreign Application Priority Data
Aug. 1, 2003 (JP) 2003285300

(51) Int. Cl. B25C 3/00

(52) U.S. Cl. 227/107

(57) ABSTRACT

A driver 12 is provided so that it can move up and down, and a C-shaped leading-end staple of sheet-shaped connected-staples 1 is pressed to a guide surface 15 by a pusher 13 so as to be opposed to a leading end of the driver 12. The pusher 13 includes a support surface 13b which is positioned near and under a center of the staple and protrudes so that one part of the support surface faces to an inside of at least the substantially C-shaped leading-end staple 1. Therefore, it is possible to prevent a cutting noise from being produced when the leading-end staple is torn off from the next staple in order to drive the leading-end staple in sheets of paper to be stapled.

### TECHNICAL FIELD

The present invention relates to a stapler which staples sheets of paper to be stapled together at a desired position.

### BACKGROUND ART

Conventionally, a copier has been known in which a stack tray provided with a stapler that staples copied sheets of paper at a desired position (for example, JP-B2-2778460).

The stapler is provided with a driver mounted on an upper frame of a frame divided up and low, and the driver is moved up and down by a link mechanism operationally coupled through a drive part such as an electric power motor and a reduction gear. By the driver, a substantially C-shaped staple is driven to the sheets of paper stacked on the lower frame.

On the other hand, when the drive operation is carried out, it is necessary that a leading-edge staple is always set in a proper position, that is, in a proper position under the driver, and that unexpected slippage of the staple when the driver pushes out the leading-edge staple is prevented.

Generally, as a mechanism for setting the leading-edge staple in the proper position and simultaneously preventing the unexpected slippage of the staple, a pusher for pressing the staple to a guide surface by means of energizing force of a spring is provided in the stapler (refer to, for example, JP-A-2000-343451).

FIGS. 3A, 3B and 3C show one example of an electric stapler provided with the pusher. Reference numeral 1 is a staple, and at least the leading-edge staple is formed in substantially C-shape. Reference numeral 2 is a driver which separates the staple 1 from the next staple 1 and pushes out the staple 1 so as to insert the both ends of the staple 1 into the sheets of paper to be stapled, reference numeral 3 is a pusher, and reference numeral 4 is a staple guide.

The staples 1 are formed in a sheet where many staples in straight wire conditions are connected by an adhesive bond. The sheet-shaped staples 1 are accommodated in a magazine (not shown) and stacked in an up-and-down direction. Of the sheet-shaped staples located in the uppermost (or lowermost) position, the staple 1 located in a leading-end position in a front-and-back direction is formed in the substantially C-shape, and thereafter the C-shaped staple 1 is driven by the driver 2. At this time, by a forming plate (not shown) that descends in synchronization with the driver 2, the next staple 1 is formed in the C-shape.

The driver 2 is provided with a pair of leg portions 2a which come into contact with vicinity of both corners of the staple 1 and push out the staple 1 so that the both ends of the C-shaped staple 1 are not deformed unexpectedly, when the staple 1 is penetrating into the comparatively thick sheets of paper to be stapled, by a load from a side of the sheets of paper to be stapled.

The pusher 3 supports the leading-end staple 1 and the next staple 1, of the sheet-shaped staples 1 accommodated in the magazine and guided by the staple guide 4, in the forming state in the C-shape, and includes a contact surface 3a for pressing the leading-end staple 1 to the guide surface forward.

In the thus constructed stapler, by the leg portions 2a provided for the driver 2, the staple 1 is driven to the sheets of paper to be stapled. Therefore, space is formed near the center in the left and right direction of the staple 1.

Therefore, when the leading-end staple 1 is driven to the sheets of paper to be stapled by the driver 2, in case that the leading-end staple 1 is separated from the next staple 1, a strain is produced with a vicinity of the center of the staple 1 as an apex, as shown in FIG. 3C. Therefore, the separation timing near the center goes slower than the separation timing near the corners.

Due to a lag of this separation timing, by addition of elastic restoring force for the stain of the staple 1 to the further descending force of the driver 2, the leading-end staple 1 is torn off from the next staple 1 by the considerable power. In this result, there is a problem that the cutting noise is produced in this tearing-off.

### DISCLOSURE OF THE INVENTION

In order to solve the above problem, an object of the invention is to provide a stapler which is capable of preventing the occurrence of cutting noise when the leading-end staple is torn off from the next staple in order to drive the leading-end staple in the sheets of paper to be stapled.

In order to solve the above problem, the stapler of the invention includes a driver which is movable up and down in relation to a magazine in which sheet-shaped connected staples are accommodated, and a pusher which pushes the C-shaped leading-end staple of the sheet-shaped connected staples to a guide surface for guiding a movement of the driver so that the leading-end staple is opposed to a leading end of the driver. The pusher has a support surface which is positioned near and under a center of the staple, and protrudes so that a part of the support surface faces to an inside of at least the C-shaped leading-end staple.

Further, a protrusion surface of the support surface opposed to the leading-end staple may tilt in the driving direction of the driver.

### BRIEF DESCRIPTION OF THE DRAWINGS

FIG. 1A is a perspective view of a main portion of an electric stapler of the invention,

FIG. 1B is a front view of the main portion in an initial state when a leading-end staple is torn off from the next staple, and

FIG. 1C is a front view of the main portion in a middle state when the leading-end staple is torn off from the next staple.

FIG. 2A is a sectional view of the main portion in the initial state when the leading-end staple is torn off from the next staple, and

FIG. 2B is a sectional view of the main portion in a middle state when the leading-end staple is torn off from the next staple.

FIG. 3A is a perspective view of a main portion of a conventional electric stapler,

FIG. 3B is a front view of the main portion in the stapler of FIG. 3A in an initial state when a leading-end staple is torn off from the next staple, and

FIG. 3C is a front view of the main portion in the stapler of FIG. 3A in a middle state when the leading-end staple is torn off from the next staple.

### BEST MODE FOR CARRYING OUT THE INVENTION

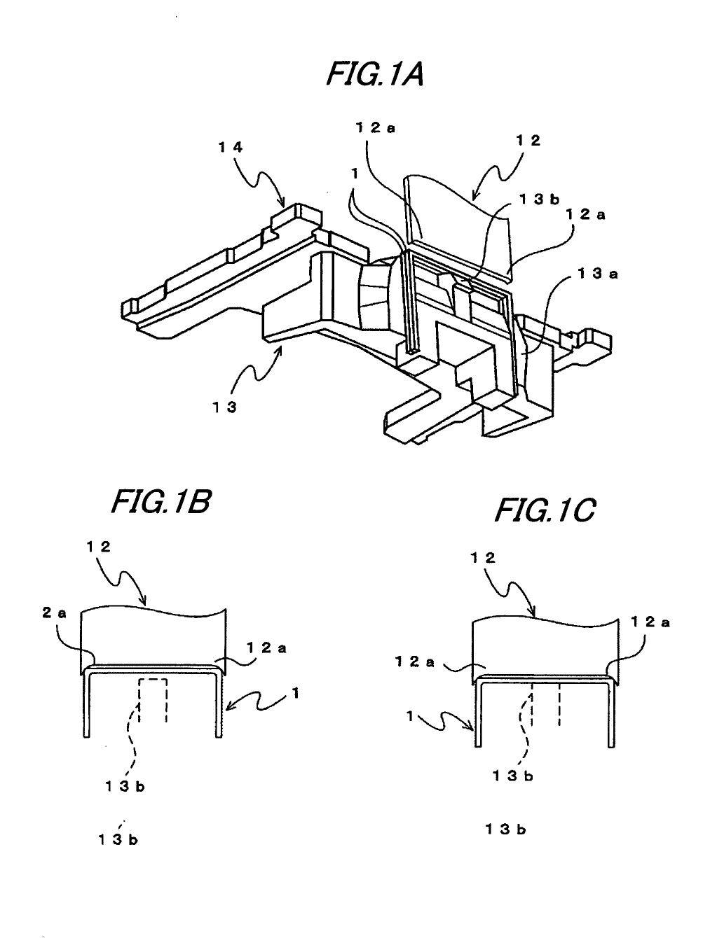

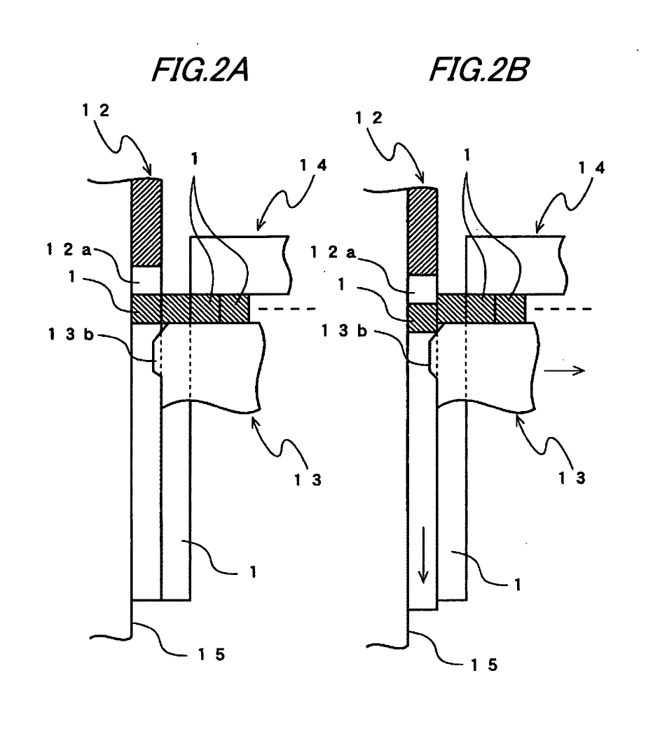

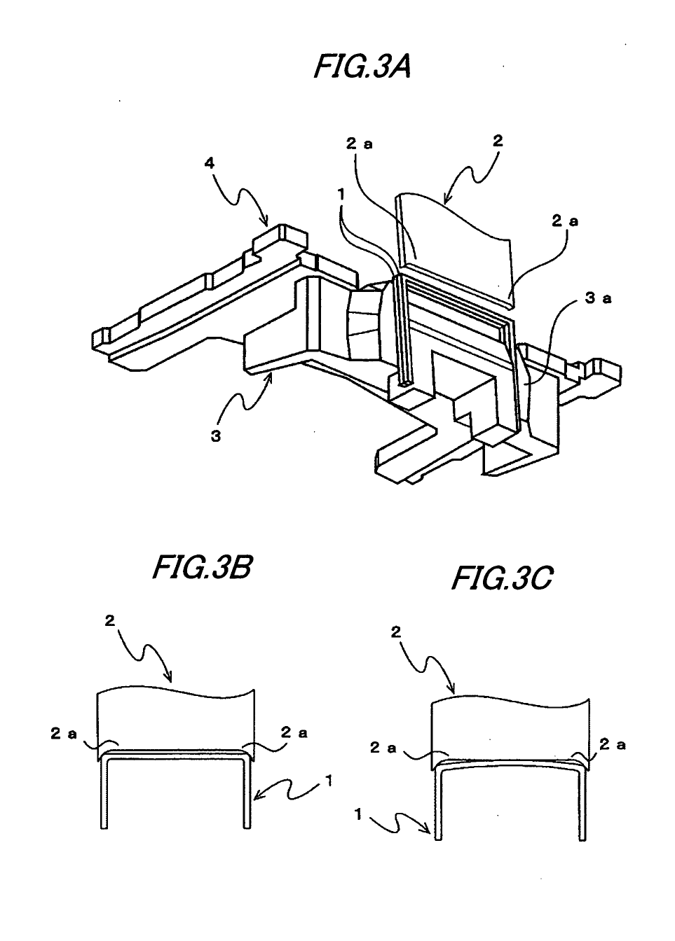

Next, the invention will be described with reference to an electric stapler. FIG. 1A is a perspective view of a main portion of an electric stapler, FIG. 1B is a front view of the main portion in an initial state when a leading-end staple is torn off from the next staple, and FIG. 1C is a front view of the main portion in a middle state when the leading-end staple is torn off from the next staple. FIG. 2A is a sectional view of the main portion in the initial state when the leading-end staple is torn off from the next staple, and FIG. 2B is a sectional view of the main portion in the middle state when the leading-end staple is torn off from the next staple.

In FIGS. 1A, 1B and 1C, reference numeral 1 is a staple. At least a leading-end staple is formed in the C-shape. Reference numeral 12 is a driver which separates the staple 1 from the next staple 1 and pushes out the staple 1 so that both ends of the staple 1 penetrate into the sheets of paper to be stapled. Reference numeral 13 is a pusher. Reference numeral 14 is a staple guide. Reference numeral 15 is a guide surface for guiding a slide motion of the driver 12. The substantially C-shaped staple has a linear upper portion, and both end portions extending perpendicularly from the left and right ends of the upper portion. The driver 15 is provided so that it can move up and down in the up-and-down direction. When the driver 15 is driven downward, it drives the leading-end staple.

The driver 12 is provided with a pair of leg portions 12a which come into contact with vicinities of both corners of the staple 1 and push out the staple 1 so that the both end of the substantially C-shaped staple 1 is not deformed unexpectedly, when the staple 1 is penetrating into the comparatively thick sheets of paper to be stapled, by a load from the side of the sheets of paper to be stapled.

The pusher 13 is always urged toward the guide surface 15 side (in the forward direction) by a not-shown spring. Further, the pusher 13 includes a contact surface 13a for pressing the leading-end staple 1 and the next staple 1 of the sheet-shaped staples 1 accommodated in the magazine and guided by the staple guide 14, to the guide surface 15 in a state where their staples 1 are formed in the C-shape; and a support surface 13b which is located near and under the center in the left and right direction of the staple 1 and protrudes so that a part of the support surface faces to at least the leading-end staple 1. Further, it is preferable that the protrusion surface of the support surface 13b to the staple 1 side tilts in the driving direction of the driver 12.

Under such the structure, when the driver 12 moves down and pushes down the vicinities of the both corners of the leading-end staple 1 by the leg portions 12a, the leading-end staple 1 intends to separate from the next staple 1.

At this time, as shown in FIG. 2A, the support surface 13b of the pusher 13 is located near the center portion of the leading-end staple 1, and as shown in FIG. 2B, nearly simultaneously with separation start of the leading-end staple 1, the vicinity of the center of the leading-end staple 1 comes into contact with the support surface 13b. Therefore, even if the descending power of the driver 12 is further applied to the staple 1, the leading-end staple 1 is separated from the next staple 1 without the stain, and the occurrence of the cutting noise in tearing-off of the leading-end staple 1 is prevented.

With the descent of the driver 12, the leading-end staple 1 descends while interfering with the support surface 13b. Therefore, the pusher 13 retreats backward (in the opposite direction to the guide surface) against energy of the spring which energizes the pusher 13 to the guide surface 15 side. In result, driving into the sheets of paper to be stapled is executed unforcedly.

The both ends of the staple 1 after penetrating the sheets of paper to be stapled are bent on the back surface side of the paper by the known clincher. Hereby, binding of the sheets of paper to be stapled is completed.

Further, as a drive mechanism of the driver 12, and the constitution and a drive mechanism in which the wire-shaped staple 1 is formed in the C-shape, the known may be adopted.

### INDUSTRIAL APPLICABILITY

In the stapler of the invention, the driver is provided so that it can move up and down in relation to the magazine in which sheet shaped connected staples are accommodated, the vicinity of the center of the C-shaped leading-end staple of the sheet shaped connected staples is pressed to the guide surface by the pusher so as to be opposed to the leading end of the driver, and the pusher includes the support surface which is located near and under the center of the staple and protrudes so that one part faces to the inside of at least the nearly C-shaped leading-end staple. Therefore, it is possible to prevent the cutting noise from being produced when the leading-end staple is torn off from the next staple in order to drive the leading-end staple in the sheets of paper to be stapled.

1. A stapler comprising:
a driver that is movable up and down relative to a magazine accommodating connected staples;
a guide surface that guides a movement of the driver; and
a pusher that presses a leading-end staple of the connected staples to the guide surface,
wherein the pusher includes a support surface, wherein a part of the support surface protrudes to an inside of the leading-end staple.

2. The stapler according to claim 1, wherein at least the leading-end staple of the connected staples is formed in a C-shape having an upper portion and both end portions substantially perpendicularly extending from both ends of the upper portion; and
the support surface is located near and under a center in the right and left direction of the upper portion of the leading-end staple.

3. The stapler according to claim 2, wherein the driver includes a pair of leg portions that come into contact with both corners of the C-shaped leading-end staple and push out the leading-end staple.

4. The stapler according to claim 1, wherein a protrusion surface of the support surface opposed to the leading-end staple tilts in a driving direction of the driver.

5. The stapler according to claim 4, wherein the pusher is urged toward the guide surface, and
when the leading-end staple is driven by the driver, the leading-end staple is moved downward while interfering with the tilting protrusion surface, and the pusher retreats in an opposite direction to the guide surface.
